(19) United States
(12) Patent Application Publication
(10) Pub. No.: US 2005/0177838 A1
(43) Pub. Date: Aug. 11, 2005

(54) Disk apparatus

(75) Inventors: Yuji Yamada, Saitama (JP); Keiichi Takagi, Saitama (JP); Toshiyuki Kaneko, Saitama (JP); Naozumi Teramoto, Saitama (JP); Kouichi Yaeguchi, Saitama (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 11/029,020

(22) Filed: Jan. 5, 2005

(30) Foreign Application Priority Data
Jan. 9, 2004 (JP) 2004-004520

(51) Int. Cl. G11B 7/085

(52) U.S. Cl. 720/600; 369/30.27

(57) ABSTRACT

A movable unit (50) is disposed between a loaded recording medium (1) and a bottom surface (4a) of a base chassis (4) opposite to the surface of the loaded recording medium (1). The movable unit includes a spindle motor (53), a head (51), guide shafts (52a, 52b) for supporting the head (51) movably in a radius direction of the recording medium (1), and a movable holding device (5), disposed at the base chassis (4) swingable downward to the bottom surface (4a), for holding the spindle motor (53), the head (51) and the guide shafts (52a, 52b). The movable holding device (5) holds at least one of the spindle motor (53), the head (51) and the guide shafts (52a, 52b) movably in a direction moving away from the bottom surface (4a) relative to the movable holding device (5). A limiting device (60a, 60b) is disposed between the movable unit (50) and the bottom surface (4a) for limiting a movable range of the movable unit (50), so that at least a part of the movable unit (50) is maintained with a distance apart from the bottom surface (4a), even if the movable holding device (5) swings down.

### BACKGROUND OF THE INVENTION

1. Field of the Invention

The present invention relates to a disk apparatus for loading an optical disk such as a DVD or a CD (Compact Disc) and performing one of or both of recording and reproducing information to the disk.

2. Description of the Related Art

In this type of disk apparatus, when a disk is inserted, the disk is loaded to a predetermined position on a spindle motor. When the disk is loaded, a mechanical frame, which integrally holds a head for recording or reproduction, the spindle motor and so on, swings down to escape temporarily from a disk loading path. Then, once the loading is completed, the mechanical frame swings back to a predetermined position to clamp the disk at a clamp portion on the spindle. Then, while the spindle motor rotates the disk, the head irradiates a record surface of the disk with light to record or reproduce the information.

In the field of such a disk apparatus, intensive efforts are in progress for providing a thin-shaped apparatus. Some techniques are taken for providing a thin-shaped apparatus. One of the techniques is to reduce the thickness of the spindle motor or the head, because the spatial height from the disk loading path to the bottom plate depends on the thickness of the spindle motor or the head. Another of the techniques is that a hole is made in a part of the bottom plate corresponding to the positions of the head and the like, so as to prevent the head and the like contacting with the base plate and escape the height of the component.

On the other hand, Japanese Patent Application Laid-Open No. 2002-312955 describes a technology in which the disk loading path is created by moving a traverse base (serving as a mechanical frame) towards the bottom plate of the disk apparatus. In this technique, guide shafts for supporting the head are held by a traverse base via an elastic member. The traverse base is arranged parallel to the bottom plate. An contact portion is disposed at the bottom plate. When the disk is loaded, the traverse base is moved towards the bottom plate. Although the traverse plate is moved towards the bottom plate, the position (attitude) of the traverse base is kept parallel to the bottom plate. Due to the movement of the traverse base, the head and the guide shafts are pushed by the traverse base and thereby moved towards the bottom plate. When the head approaches the bottom plate, the guide shafts come into contact with the contact portion, and the elastic member to support guide shafts is compressed. Thereby, in spite of the movement of the traverse base towards the bottom plate, the head is prevented from coming into contact with the bottom plate. Additionally, the travel distance of the head is shortened.

However, if the thickness of the spindle motor is reduced, a torque may be reduced. This may cause the time required for the acceleration or deceleration of the disk rotation to elongate. Furthermore, since a constitutional material of the motor becomes thinner, the strength may be reduced. This may cause the deformation due to impact from the outside or resonance. Furthermore, it is difficult to thin the head in view of the requirement of keeping a sufficient light beam diameter or a sufficient strength. Furthermore, the technique of providing a hole through the bottom plate has a problem that dust enters the inside of the disk apparatus through the hole. To address this problem, it is not impossible to remedy the hole with a tape or the like. However, this may increase the total thickness of the disk apparatus.

On the other hand, in the technology described in the above reference, it is difficult to provide effectively the thin-shaped apparatus, because the whole of the traverse base is escaped in a thickness direction of the apparatus.

### SUMMARY OF THE INVENTION

It is therefore an object of the present invention to provide the reliable disk apparatus suitable for a thin-shaped apparatus.

To achieve the above-mentioned object, a disk apparatus of the present invention is provided. The disk apparatus is for loading a disk-like recording medium to a predetermined position in the inside thereof, and performing recording information in the loaded recording medium or reproducing the information recorded in the loaded recording medium. The disk apparatus of the present invention comprises: a base chassis having a surface facing a surface of the loaded recording medium; a movable unit having (i) a spindle motor for rotating the loaded recording medium, (ii) a head for performing the recording of the information or the reproducing of the information to the loaded recording medium, (iii) a guide shaft for supporting the head movably in a radius direction of the loaded recording medium, and (iv) a movable holding device holding the spindle motor, the head and the guide shaft; a supporting device for supporting the movable holding device at a supporting point located between the loaded recording medium and the base chassis such that the movable holding device can swing about the supporting point between the loaded recording medium and the base chassis in a direction approximately perpendicular to the surface of the base chassis; and a limiting device for limiting a movable range of the head by coming into contact with the head or the guide shaft when the movable holding device swings towards the surface of the base chassis. The movable holding device holds the head or the guide shaft movably in a direction away from the surface of the base chassis.

In the disk apparatus, the recording medium is inserted in the disk apparatus and loaded to the predetermined position for performing the recording or the reproducing. Simultaneously with or before the loading of the recording medium, a loading path of the recording medium is created by swinging the movable holding device towards the surface of the base chassis. The supporting device supports the movable holding device at the supporting point located between the loaded recording medium and the base chassis. Namely, the movable holding device is located between the loaded recording medium and the base chassis and supported by the supporting device at the supporting point in this place. The movable holding device can swing about the supporting point between the loaded recording medium and the base chassis in the direction approximately perpendicular to the surface of the base chassis. The supporting point acts as a fulcrum of the swing motion of the movable holding device. The supporting point is provided with one or two connection points. In the case that the supporting point is provided with two connection points, the line connecting between two connection points acts as an axis of the swing motion. The supporting point may be preferably positioned away from an entrance of the recording medium such as a disk-insert-slot or the like. In the swing motion, the end side of the movable holding device near the entrance of the recording medium moves so as to approach the surface of the base chassis. By this motion, the loading path is created. Incidentally, in order to achieve the swing motion of the movable holding device, it is preferable to provide the structure that the movable holding device rotates about the supporting point. In this case, it is preferable that the position of the center of the rotation (i.e. the position of the supporting point) is away from the entrance of the recording medium. For example, the center of the rotation may be positioned at an end portion of the movable holding device on the side away from the entrance of the recording medium. Alternatively, the center of the rotation may be shifted closer to the middle portion of the movable holding device. In this case, in the swing motion, an end portion of the movable holding device near the entrance of the recording medium moves closer to the surface of the base chassis and the opposite end portion moves away from the surface of the base chassis. Alternatively, the swing motion can be achieved by using different structures. For example, the movable holding device may be tilted relative to the loading direction of the recording medium, and further tilted relative to the direction orthogonal to the loading direction in the plane parallel to the surface of the base chassis. Alternatively, the movable holding device may be moved towards the surface of the base chassis in the direction approximately perpendicular to the surface of the base chassis and simultaneously or continuously moved away from the entrance of the recording medium in the direction parallel to the surface of the base chassis.

When the movable holding device swings, one or some of the components held by the movable holding device, i.e. the spindle motor, the head and the guide shaft, approaches the surface of the base chassis. However, these components do not come into contact with the surface of the base chassis because the movable range of the movable unit including these components is limited by the limiting device. Thereby, the damage or deviation of the movable unit caused by the impact of the contact with the surface of the base chassis can be prevented. Furthermore, the movable holding device holds the head or the guide shaft movably in the direction away from the surface of the base chassis. For this structure, when the movable holding device swings, the head included in the components held by the movable holding device can move independently of the movable holding device in the direction away from the surface of the base chassis. Therefore, the total measurement of the movable unit becomes small in the direction perpendicular to the surface of the base chassis, while the shape of each component of the movable unit is not changed. Assuming that the head is fixed to the movable holding device, the total measurement of the movable unit become large in the direction perpendicular to the surface of the base chassis when the movable holding device is tilted in the swing motion. This is because the measurement of the head become large in the direction perpendicular to the surface of the base chassis when the head is tilted together with the movable holding device, or because the total measurement of the movable unit extends in the direction perpendicular to the surface of the base chassis due to the moving of the head, which has a relatively large thickness, towards the base chassis together with the end portion of the movable holding device. However, in the disk apparatus of the present invention, the head can move independently of the movable holding device in the direction away from the surface of the base chassis when the movable holding device is tilted. Therefore, the measurement of the head or the total measurement of the movable unit is small in the direction perpendicular to the surface of the base chassis when the movable holding device is tilted.

As the result, it is possible to provide a thin-shaped disk apparatus without sacrificing its reliability.

In an aspect of the disk apparatus of the present invention, when the movable holding device swings towards the surface of the base chassis, the position (attitude) of the head or the guide shaft gets close to a parallel position relative to the surface of the base chassis, in comparison with positions (attitudes) of the movable holding device and the spindle motor, by moving independently of the movable holding device in the direction away from the surface of the base chassis.

In this aspect, when the movable holding device is tilted in the swing motion, the head is moved close to the position (attitude) parallel to the surface of the base chassis. Alternatively, when the movable holding device is tilted in the swing motion, the guide shaft and the head supported by the guide shaft are moved close to the position (attitude) parallel to the surface of the base chassis. Therefore, the measurement of the head or the total measurement of the movable unit is small in the direction perpendicular to the surface of the base chassis when the movable holding device is tilted.

In another aspect of the disk apparatus of the present invention, when the movable holding device swings towards the surface of the base chassis, the head or the guide shaft is moved independently of the movable holding device in the direction away from the surface of the base chassis by coming into contact with the limiting device.

In this aspect, when the movable holding device swings toward the surface of the base chassis in the swing motion, the head comes into contact with the limiting device. Then, the head is moved independently of the movable holding device in the direction away from the surface of the base chassis. Alternatively, when the movable holding device swings toward the surface of the base chassis in the swing motion, the guide shaft comes into contact with the limiting device. Then, the guide shaft and the head supported by the guide shaft are moved independently of the movable holding device in the direction away from the surface of the base chassis. Therefore, the measurement of the head or the total measurement of components including the head and the guide shaft is small in the direction perpendicular to the surface of the base chassis when the movable holding device swings towards the surface of the base chassis. Therefore, the sufficiently wide loading path can be created.

In another aspect of the disk apparatus of the present invention, the limiting device is disposed on the guide shaft and extends towards the surface of the base chassis, and the tip of the limiting device comes into contact with the surface of the base chassis, when the movable holding device swings toward the surface of the base chassis.

In this aspect, when the movable holding device swings toward the surface of the base chassis in the swing motion, the guide shaft is away from the surface of the base chassis via the limiting device. Namely, the limiting device acts as a strut or prop. Since the head is supported by the guide shaft, the head is away from the surface of the base chassis together with the guide shaft. The head includes components involving high accuracy, such as the light source, photoreceiver and so on. Therefore, the head is vulnerable to the impact. Since the limiting device disposed on the guide shaft, the head can be protected from the damage caused by the impact of the contact between the limiting device and the base chassis.

In another aspect of the disk apparatus having the structure that the limiting device is disposed on the guide shaft, the head comprises a light source for irradiating the recording medium with a light beam and a photoreceiver for receiving the light beam reflected from the loaded recording medium, and the limiting device is disposed near at least one of the light source and the photoreceiver.

The light source or the photoreceiver is a severe portion with the accuracy in the head. Disposing the limiting portion near the severe portion makes it possible to prevent such a portion from crashing with the surface of the base chassis.

In another aspect of the disk apparatus of the present invention, the limiting device is disposed on the head and extends towards the surface of the base chassis, and the tip of the limiting device comes into contact with the surface of the base chassis, when the movable holding device swings towards the surface of the base chassis.

In this aspect, when the movable holding device swings toward the surface of the base chassis in the swing motion, the head is away from the surface of the base chassis via the limiting device. Namely, the limiting device acts as a strut or prop. Thereby, the head including severe components with the accuracy such as the light source or the photoreceiver can be securely maintained with a distance apart from the surface of the base chassis.

In another aspect of the disk apparatus of the present invention, the limiting device is disposed on the surface of the base chassis and extends toward the head or the guide shaft, and the tip of the limiting device comes into contact with the head or the guide shaft, when the movable holding device swings towards the surface of the base chassis.

In this aspect, when the movable holding device swings in the swing motion, at least the head held by the movable holding device is maintained with a distance apart from the surface of the base chassis, because the limiting device projecting from the surface of the base chassis acts as a strut or prop. Thereby, at least a part of the movable unit is securely maintained with a distance apart from the surface of the base chassis.

In another aspect of the disk apparatus of the present invention, the movable holding device holds the guide shaft via an elastic device, and the elastic device is compressible in the direction away from the surface of the base chassis.

In this aspect, when the head or the guide shaft is moved in the direction away from the surface of the base chassis in the swing motion, the elastic device is compressed. Therefore, it is possible to move the head smoothly. In the aspect of adopting the structure that the guide shaft comes into contact with the limiting device, the elastic device lessens an impact of the contact between the guide shaft and the limiting device by giving the force to the guide shaft towards the surface of the base chassis.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a plan view of the disk apparatus according to an embodiment of the present invention.

FIG. 2 is a plan view of the mechanical frame shown in FIG. 1 as seen from the front surface.

FIG. 3 is a plan view of the mechanical frame shown in FIG. 1 as seen from the rear surface.

FIG. 4 is a sectional view taken along a line A-A′ of FIG. 1.

FIG. 5 is a view illustrating the shaft holding device shown in FIG. 4.

FIG. 6 is a sectional view taken along the line A-A′, showing a waiting mode of the movable unit shown in FIG. 4.

FIG. 7 is a sectional view taken along the line A-A′, showing a status on the way to loading of the movable unit shown in FIG. 4.

FIG. 8 is a sectional view taken along the line A-A′, showing a status after loading of the movable unit shown in FIG. 4.

### DETAILED DESCRIPTION OF THE PREFERRED EMBODIMENTS

Embodiments of the present invention will now be discussed, with reference to drawings.

Entire Configuration of Disk Apparatus

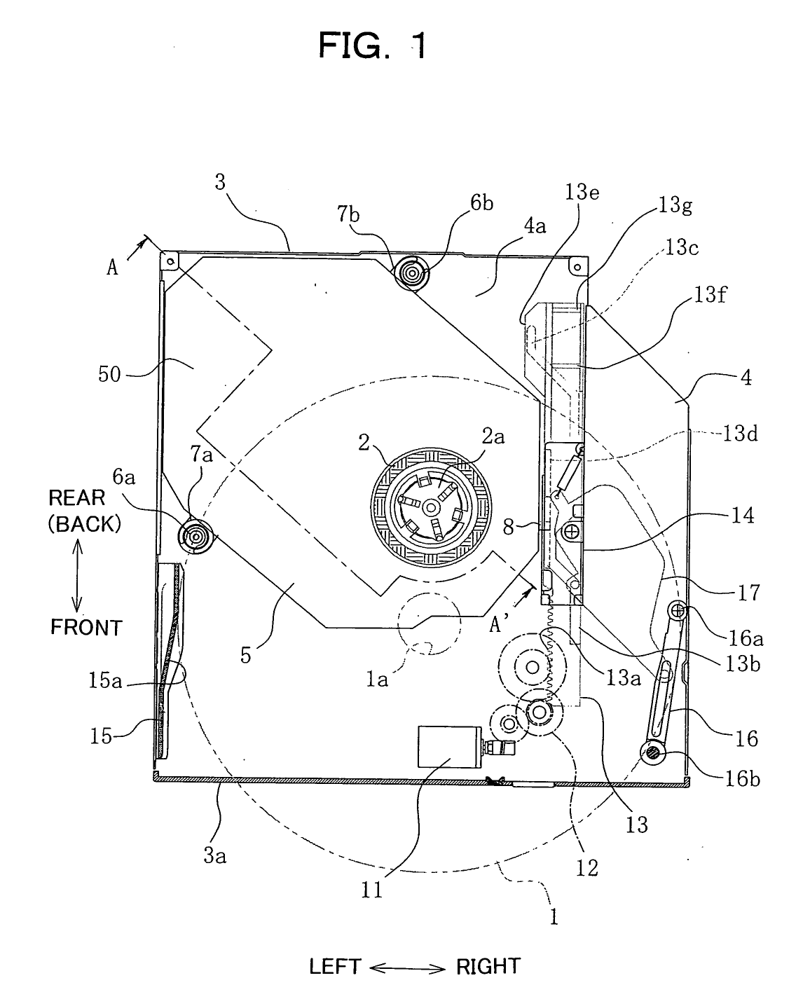

Firstly, the construction of the disk apparatus of this embodiment will be discussed as a whole, with reference to FIG. 1. FIG. 1 illustrates the disk apparatus, in a plan view with an optical disk 1 on loading, and internal main components seen through the upper part of the housing are drawn. Incidentally, the following discussion will be made under the assumption that the disk apparatus is a horizontal type for the sake of convenience, but a vertical type is also applicable. The operation, construction and advantages in the vertical type are significantly the same as the horizontal type.

In FIG. 1, the disk apparatus is for recording and reproducing the information such as video or music to the optical disk 1, and adapted to load the optical disk 1 into a housing 3, clamp a center hole 1a by a clamp portion 2a, and hold the optical disk 1 on a turn table 2 co-rotatably. Incidentally, in order to load the optical disk 1, an arm member or the like is provided to grab the circumference of the rotating optical disk 1 to facilitate the loading. Nevertheless, components for this purpose are not shown in FIG. 1 and the explanation about them is omitted as appropriate.

A panel 3a having an insert slot (not shown) for the disk 1 is fixed on the front surface of the housing 3. A base chassis 4 is disposed at a bottom of the housing 3. The base chassis 4 has the bottom surface 4a facing a recording surface of the optical disk 1.

Between the bottom surface 4a of the base chassis 4 and a mounting area of the disk 1, a mechanical frame 5 is disposed as an example of the “movable holding device” according to the present invention. The mechanical frame 5 is provided with a turn table 2, which is placed at approximate center of the base chassis 4. The mechanical frame 5 is connected to the base chassis 4 by two universal joints 6a, 6b at two points on side edges of the mechanical frame 5. Universal joints 6a, 6b are made of, respectively, the shanks of shoulder screws screwed on the base chassis 4, forks 7a, 7b projecting from the frame 5 and grasping the shanks of the screws, and rubber bushings inserted between the shanks of the screws and forks 7a, 7b. The structure including the universal joints 6a, 6b and the forks 7a, 7b is an example of the “supporting device”. The couple of the universal joint 6a and the forks 7a and the couple of the universal joint 6b and the forks 7b are connection points, respectively. A pin 8 acting as a cam follower projects from the opposite side of the fulcrum of the frame 5. The pin 8 is restricted by a cam discussed below, resulting in a “swing down” movement of the mechanical frame 5. Namely, two universal joints 6a, 6b support the mechanical frame 5. They act as the fulcrum of the mechanical frame 5. Although the mechanical frame 5 can rotates about the fulcrum, the rotation of the mechanical frame 5 is restricted by the pin 8. In this manner, the mechanical frame 5 can swing the up-and-down direction, and the opposite side of the fulcrum the mechanical frame 5 can move up and down.

A slider 13 is provided with a rack 13a and a plurality kinds of cam 13b, 13c, 13d, 13e, 13f and 13g. It is disposed slidably in the back-and-forth direction under guidance of a holder 14. The side surface of the slider 13 is formed of the cam 13d. The cam 13d has a cam slot. The cam slot extends in the back-and-forth direction, and its vertical position (the position of the cam slot in the up-and-down direction) varies. Once the slider 13 starts to move forward (downward in FIG. 1), the pin 8 moves backward relative to the slider 13 in the cam slot. When the pin 8 moves in the cam slot, the pin 8 also moves in the up-and-down direction depending on the vertical position of the cam slot.

Furthermore, in the housing 3, a motor 11 and a gear train 12 are disposed. The motor 11 is for supplying a driving power to each mechanism performing a series of loading operations including loading, holding and ejecting of the optical disk 1. The gear train 12 is for transmitting the power to each mechanism. The gear train 12 serves as a speed reducer for reducing the rotational speed of the motor 11. The gear train 12 is disposed in a manner that a gear at beginning engages with a worm on an output shaft of the motor 11 and a gear at end engages with dents of the rack 13a.

Therefore, once the motor 11 rotates in the forward or reverse direction, the slider 13 moves straightly in the back-and-forth direction, so that the slider 13 can reciprocate in the back-and-forth direction by switching the rotational direction of the motor 11. In association with this reciprocating motion of the slider 13, other various links co-operate for loading and ejecting the optical disk 1, as well as holding and releasing the optical disk 1. The pin 8 of the mechanical frame 5 also moves relatively in the cam slot accompanying with the reciprocating motion of the slider 13. This causes the up-and-down motion of the pin 8. This up-and-down motion of the pin 8 causes the “swing down” motion of the mechanical frame 5 about the fulcrum, i.e., the points supported by the universal joints 6a, 6b.

At the part on the left-edge side of the base chassis 4 and near the panel 3a, a disk guide 15 is fixed. The disk guide 15 has a guide slot 15a for supporting the circumference of the optical disk 1. The disk guide 15 guides for loading and ejecting the optical disk 1 at the constant position on the base chassis 4, while the slider 13 moves.

On the other hand, at the part on the right-edge side of the base chassis 4 and near the panel 3a, a pulling-in lever 16 is disposed. The pulling-in lever 16 is supported by a supporting-point pin 16a. A roller 16b is attached to the tip portion of the pulling-in lever 16. The roller 16b come into contact with the circumference of the optical disk 1 to pull-in the disk 1. Furthermore, the pulling-in lever 16 is connected to the slider 13 via a connection arm 17. The connection arm 17 is connected to a holder 14 via a pulling spring 18. The pulling spring 18 exerts a force to the pulling-in lever 16 in the direction that the roller 16b pulls the optical disk 1 into the housing 3.

That is, if the slider 13 slides towards the panel 3a due to the normal rotation of the motor 11, the pulling-in lever 16 rotates to a clockwise direction about the supporting-point pin 16a via the connection arm 17. Then, the roller 16b comes into contact with the right side of the circumference of the optical disk 1, so that the optical disk 1 is pulled into the housing 3. At this time, the optical disk 1 is guided into a backward direction of the housing 3, while the left side of the circumference of the disk 1 is hold by the disk guide 15. Incidentally, if the optical disk 1 is pulled further by the roller 16b, for example, the left side of the circumference is held by a centering arm disposed deeply inside of the disk guide 15, and the right back of the circumference is held by another arm or the like supported at a position deeply inside of the housing 3. The latter arm has a roller at the tip portion, and rotates in the clockwise direction at the deep position on the right side of the housing 3. Thus, the optical disk 1 is centered in the housing 3. The ejection of the optical disk 1 from the housing 3 is achieved by the reverse operation of the aforementioned various links due to the reverse rotation of the motor 11.

(Construction of Mechanical Frame)

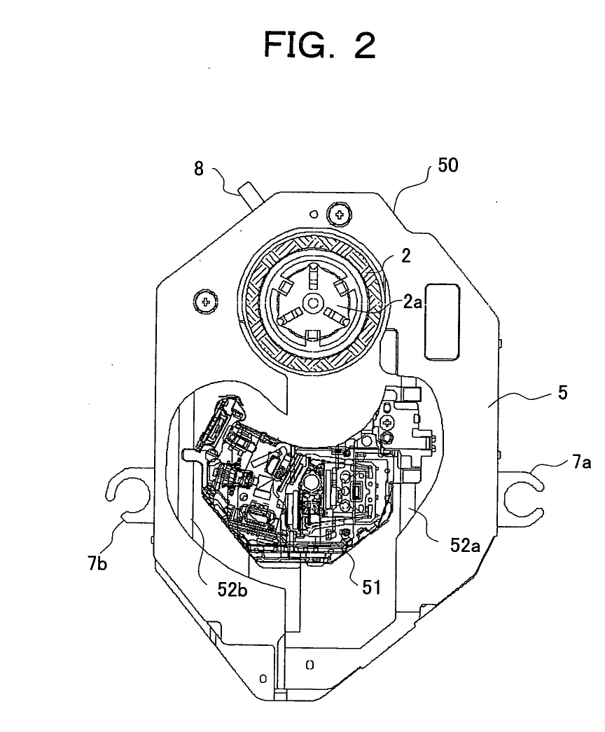

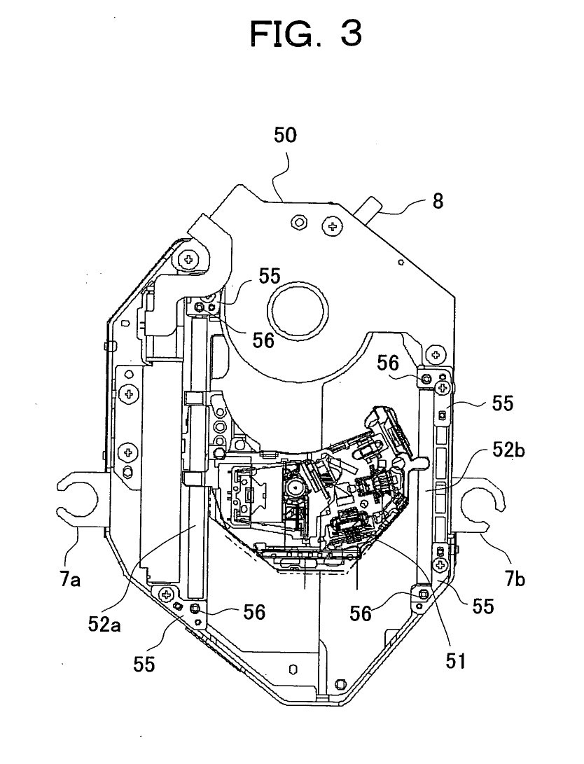

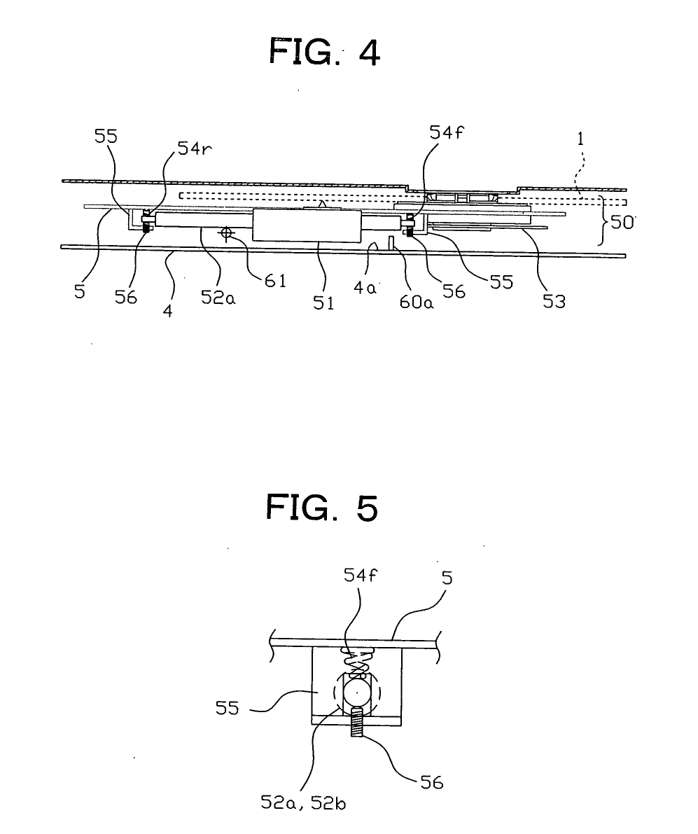

Now, the mechanical frame as an example of the “movable holding device” according to the present invention will be explained in detail, with reference to FIG. 2 to FIG. 4. FIG. 2 is a plan view of the mechanical frame 5 as seen from its front surface (i.e. a surface facing the optical disk 1), and FIG. 3 is a plan view as seen from its rear surface (i.e. a surface facing the base chassis 4). FIG. 4 shows a section taken along the line A-A′ of FIG. 1.

As shown from FIG. 2 to FIG. 4, the mechanical frame 5 holds, in addition to the turn table 2, an optical head 51, guide shafts 52a, 52b supporting the optical head 51 movably in the radius direction of the optical disk 1, a spindle motor 53 for rotating the turn table 2 and so on. For this, when the mechanical frame 5 swings down, the mechanical frame 5 itself and these components held by the frame 5 move together. That is, in this embodiment, a movable unit 50 as an example of the “movable unit” according to the present invention is provided with the spindle motor 53, the optical head 51, the guide shafts 52a, 52b and the mechanical frame 5 holding these components. Incidentally, the swing-down motion of this embodiment is adapted to be a motion rotating around the rotation center 61 in FIG. 4. As shown in the figure, the rotation center 61 is placed in a position dividing the distance between one end and the other end of each guide shafts 52a, 52b at a ratio 2:1 as seen from the turn table 2. Namely, the ratio of the distance between the rotation center 61 and said one end of each guide shafts 52a, 52b positioned near the turn table 2 to the distance between the rotation center 61 and the other end of each guide shafts 52a, 52b positioned away from the turn table 2 is 2:1.

The guide shafts 52a, 52b are held to the mechanical frame 5 at one end near the turn table 2 via a coil spring 54f and the other end away from the turn table 2 via a coil spring 54r. For this, each end of the guide shafts 52a, 52b is movable in the upward direction and the downward direction relative to the mechanical frame 5. Nevertheless, as shown in FIG. 4 and FIG. 5, the movable range of each end to the guide shafts 52a, 52b is restricted by a shaft holding device 55 and an adjustable screw 56 which is attached to the shaft holding device 55. If the position of the adjustable screw 56 is adjusted, the height and tilt of the optical head 51 relative to the optical disk 1 can be indirectly adjusted.

Furthermore, limiting members 60a, 60b as an example of the “limiting device” according to the present invention is disposed on the base chassis 4 at positions opposite to guide shafts 52a, 52b so as to come into contact with the guide shafts 52a, 52b respectively at the time of the swing-down motion. The limiting members 60a, 60b are paired with each other. They are disposed at symmetrical positions, and are the same as each other in height. Therefore, the tilt of each guide shaft 52a, 52b relative to the bottom surface 4a is the same when each guide shaft 52a, 52b comes into contact with the limiting member 60a or 60b. In FIG. 4, only the limiting member 60a for the guide shaft 52a is shown. Similarly to this, the limiting member 60b is disposed for the guide shaft 52b.

That is, the limiting members 60a, 60b limit the movable range of the guide shafts 52a, 52b by coming into contact with the shafts 52a, 52b respectively so that the optical head 51 is separately from the bottom surface 4a of the base chassis 4 even in the case that the mechanical frame 5 swings down. On a base material of the optical head 51, an LD (laser diode) and the like is attached after adjusting. If the optical head 51 comes into contact with the bottom surface 4a every time when the swing-down motion, a displacement of the head position occurs due to an impact of the contact. For this, the limiting members 60a, 60b are disposed to protect components of the movable unit 50, especially the optical head 51. Incidentally, the limiting members 60a, 60b may be mounted on the base chassis 4, or may be formed integrally as a part of the base chassis 4.

(Operation of Disk apparatus)

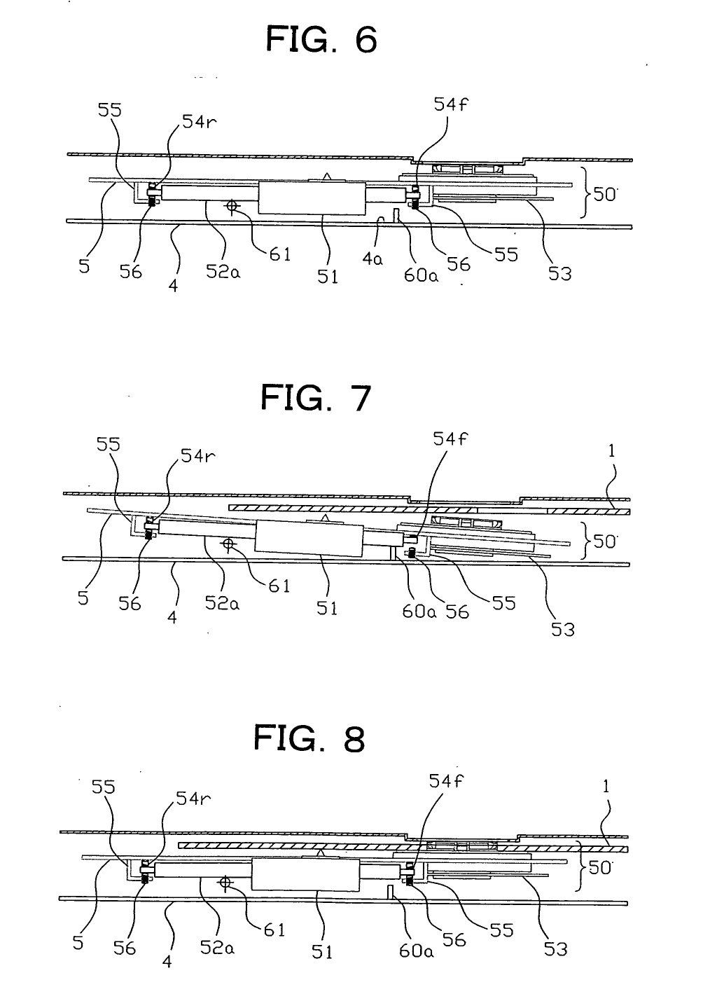

Now, the operation of the disk apparatus will be discussed, with reference to FIG. 6 to FIG. 8. FIG. 6 to FIG. 8 illustrate sections of the movable unit 50 taken along the line A-A′ of FIG. 1, in various steps: waiting, loading and after loading.

Firstly, as shown in FIG. 6, the disk apparatus is in a waiting mode. Then, once the user inserts the optical disk 1 from the insert slot (not shown) on the front panel 3a of the housing 3, the circumference of the optical disk 1 comes into contact with the roller 16b, the disk guide 15, one or more other arms (not shown) and the like so that the disk 1 is supported. In this case, once the circumference of the optical disk 1 comes into contact with the arm (not shown), a cue is given to the motor 11. In response to this, the motor 11 starts to rotate in the normal direction to advance the slider 13.

During the movement of the slider 13 to the forward direction, the connection arm 17 and then the pulling-in lever 16 rotate in a clockwise direction so that the tip-positioned roller 16b pulls the optical disk 1 into the deep inside of the housing 3. In this case, the disk guide 15 guides the circumference of the optical disk 1 by the guide slot 15a. Furthermore, the arm or the like (not shown) further supports the circumference of the optical disk 1. Thus, the optical disk 1 is inserted into the inside of the housing 3 with the circumference being supported.

Then, as shown in FIG. 7, as the slider 13 advances, the mechanical frame 5 starts to move downward because of the connection the pin 8 of the mechanical frame 5 with the cam 13d of the slider 13 and the varied vertical position of the cam slot of the cam 13d. In this manner, the mechanical frame 5 supported by the universal joints 6a, 6b swings down about the rotational center 61 to escape from the loading path of the optical disk 1. Namely, the supporting points of the mechanical frame 5 given by the universal joints 6a, 6b act the fulcrum of the swing-down motion of the mechanical frame 5. That is, the fulcrum approximately corresponds to the rotational center 61.

In this swing-down motion, the end of the mechanical frame 5 closer to the turn table 2 gets closer to the bottom surface 4a, while the opposite end of the frame 5 is lifted up, so that the space within the housing 3 is fully utilized.

If the mechanical frame 5 tends to swing down over a predetermined range, the limiting members 60a, 60b come into contact with the guide shafts 52a, 52b, respectively. The limiting members 60a, 60b acting as struts or props limits the swing-down motion of the guide shafts 52a, 52b and the optical head 51 so that these shafts and head are maintained with a distance apart from the bottom surface 4a. Consequently, herein, the movable unit 50 as a whole is maintained with a distance apart from the bottom surface 4a even during the swing-down motion.

However, at both ends of each guide shaft 52a, 52b, as shown in FIG. 7, the coil spring 54f is compressed more than the coil spring 54r. Thereby, the swing-down motion of the mechanical frame 5 continues, although the movements of the guide shafts 52a, 52b themselves and the optical head 51 are limited by the limiting members 60a, 60b. That is, the amount of the motion of the end portion of each guide shaft 52a, 52b on the coil spring 54f side relative to the mechanical frame 5 is larger than the amount of the motion of the end portion of each guide shaft 52a, 52b on the coil spring 54r side relative to the mechanical frame 5. Due to this motion, the optical head 51 and the guide shafts 52a, 52b are close to a parallel position relative to the bottom surface 4a, in comparison with the mechanical frame 5 and the spindle motor 53 in swinging down.

As the result, the measurement of a part of the movable unit 50 including the optical head 51 and the guide shafts 52a, 52b becomes small in a direction perpendicular to the bottom surface 4a, while shapes of these components are maintained. The distance between the most top position and the most bottom position of the part of the movable unit 50 including the guide shafts 52a, 52b and the components supported by the guide shafts 52a, 52b including the optical head 51 is short in the state that the mechanical frame 5 swings down and the guide shafts 52a, 52b comes into contact with the limiting members 60a, 60b, because the part of movable unit 50 is close to the parallel position relative to the bottom surface 4a. Thus, the loading path of the optical disk 1 can be maintained sufficiently. Furthermore, the movable range of the movable unit 50 at each portion such as the optical head 51 and so on is restricted by the limiting members 60, 60b, and thereby each portion is prevented from suffering impact of the contact or collision with the bottom surface 4a, so that the displacement of components is avoided.

Then, when the optical disk 1 is loaded to the right above the turn table 2 and the center hole 1a is aligned with the clamp portion 2a, the centering of the optical disk 1 is completed. During this centering, the slider 13 advances, so that, simultaneously with the completion of the centering, the mechanical frame 5 starts to move upward because of the connection the pin 8 of the mechanical frame 5 with the cam 13d of the slider 13 and the varied vertical position of the cam slot of the cam 13d. By the upward motion of the mechanical frame 5, the clamp portion 2a of the turn table 2 engages with the center hole 1a of the optical disk 1 to hold the disk 1.

As the slider 13 further advances, the pin 8 relatively moves in association with this advancement. Thereby, the mechanical frame 5 moves downward while the clamp portion 2a is holding the optical disk 1.

As shown in FIG. 8, when the slider 13 reaches the most advanced position, the motor 11 stops. That is, the operation of the movable unit 50 stops, and thus the loading is completed.

Then, the turn table 2 rotates due to the driving force from the spindle motor 53, so that the optical disk 1 held by the clamp portion 2a is rotated. Then, the optical head 51 scans this rotating optical disk 1, so that the information is recorded onto or reproduced from the optical disk 1.

The ejection of the optical disk 1 from the housing 3 is actuated by the operation of an eject switch and the like arranged on the panel 3a for example. That is, the motor 11 starts to rotate inversely, and the slider 13 starts to be retracted. Due to the retraction of the slider 13, each component acts inversely the aforementioned operation. Thereby, the optical disk 1 is ejected from the housing with supports of the guide slot 15a of the disk guide 15, the roller 16b, the arm and the like (not shown). Then, the motor 11 stops after the adjustment of the slider's position. Thereby, the disk apparatus recovers to the initial waiting mode for waiting the next insertion of the optical disk 1.

Thus, in the disk apparatus in this embodiment, since both ends of each guide shaft 52a, 52b are connected to the mechanical frame 5 via the coil springs 54f, 54r, the guide shafts 52a, 52b and the optical head 51 can move in a direction apart from the bottom surface 4a, while the mechanical frame 5 swings down towards the bottom surface 4a. Furthermore, since the limiting members 60a, 60b are disposed on the bottom surface 4a so as to come into contact with the guide shafts 52a, 52b at the time of the swing down motion, the optical head 51 moves to a direction apart from the base chassis 4 relatively to the mechanical frame 5 at the time of the swing down motion. Therefore, the total measurement in the vertical direction of the movable unit 50 becomes small in the state that the movable unit 50 is tilted in the swing-down motion in order to escape from the loading path of the optical disk 1. Hence, this disk apparatus is suitable for a thin-shaped design. Furthermore, in some kinds of conventional disk apparatus, an opening is needed in the base chassis in order to escape the optical head from the loading path. However, in the disk apparatus of the embodiment of the present invention, the opening is not needed because the optical head 51 moves to the direction apart from the base chassis 4. Therefore, it is possible to prevent dust or the like from entering the inside of the disk apparatus.

Furthermore, the limiting members 60a, 60b disposed on the bottom surface 4a act as struts or props to limit the movable range of each guide shaft 52a, 52b. Therefore, the guide shafts 52a, 52b and the optical head 51 are maintained away from the bottom surface 4a even during the swing down motion, so that the displacement or inaccuracy of these components can be avoided to maintain the reliability as the disk apparatus.

Incidentally, in this embodiment, the limiting members 60a, 60b are disposed on the bottom surface 4a. Nevertheless, the limiting members may be disposed at components of the movable unit 50, such as the optical head 51, or the guide shafts 52a, 52b. Also in this case, it is secure that components of the movable unit 50 can be maintained away from the bottom surface 4a. Incidentally, the liming members may be mounted on the optical head or the guide shafts, or may be formed integrally at predetermined positions of these components.

Furthermore, in the above embodiment, the limiting members 60a, 60b are disposed symmetrically at the same height. Nevertheless, the limiting members according to the present invention are not limited to a special positional relationship or height, insofar as a movable range of a target component of the movable unit can be appropriately limited. For example, for some shapes or positioning of components of movable unit, areas in which limiting members can be disposed do not always have a symmetric relationship with each other, or the design of the same height limiting members may rather obstruct the motion or movement of good efficiency in utilizing the space. Furthermore, if components such as the light source or the photodetector requiring the tight tolerance and vulnerable to impact are intensively mounted toward one guide shaft, while the area near the other guide shaft relatively resistant to impact, it is possible to dispose the limiting member in such a manner that the movable range of only the former guide shaft may be limited to selectively maintain one end of the optical head 51 with a distance apart from the bottom surface 4a. Incidentally, in this case, the mechanical frame 5 during the swing down motion tilts to a direction orthogonal to a disk-loading direction, i.e. a “guide shaft extending direction”. Such a complicated motion can be achieved simply by disposing the limiting member(s). Additionally, since the movement of the movable unit 50 in the up-and-down directions is not excessively limited, this configuration is advantageous for a thin-shaped design.

Thus, the required distance between the bottom surface and the optical head and other components held by the mechanical frame depends on characteristics of the components, and further depends on positions of the components. For this, the limiting member(s) may be disposed depending on these situations.

Furthermore, in the above embodiment, the limiting members 60a, 60b limits the motion of the guide shafts 52a, 52b and the optical head 51 during the swing down motion. Nevertheless, instead of the limiting members 60a, 60b, the bottom surface 4a of the base chassis 4, or the predetermined position of these components may limit the motion of these components. In other words, a part of the optical head 51 or the guide shafts 52a, 52b facing to the base chassis 4, or the base chassis 4 itself, may act as the “limiting device” according to the present invention. After the guide shafts 52a, 52b come into contact with the bottom surface 4a, the mechanical frame 5 can continue the swing down motion, and the total vertical measurement of the movable unit 50 becomes small during the swing down motion. Therefore, also in this case, the total vertical measurement of the movable unit 50 becomes small depending on the swing down motion, which is suitable for a thin-shaped design.

The invention may be embodied in other specific forms without departing from the spirit or essential characteristics thereof The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-004520 filed on Jan. 9, 2004 including the specification, claims, drawings and summary is incorporated herein by reference in its entirety.

1. A disk apparatus for loading a disk-like recording medium to a predetermined position in the inside thereof, and performing recording information in the loaded recording medium or reproducing the information recorded in the loaded recording medium, the disk apparatus comprising:
a base chassis having a surface facing a surface of the loaded recording medium;
a movable unit having (i) a spindle motor for rotating the loaded recording medium, (ii) a head for performing the recording of the information or the reproducing of the information to the loaded recording medium, (iii) a guide shaft for supporting the head movably in a radius direction of the loaded recording medium, and (iv) a movable holding device holding the spindle motor, the head and the guide shaft;
a supporting device for supporting the movable holding device at a supporting point located between the loaded recording medium and the base chassis such that the movable holding device can swing about the supporting point between the loaded recording medium and the base chassis in a direction approximately perpendicular to the surface of the base chassis; and
a limiting device for limiting a movable range of the head by coming into contact with the head or the guide shaft when the movable holding device swings towards the surface of the base chassis, wherein
the movable holding device holds the head or the guide shaft movably in a direction away from the surface of the base chassis.

2. The disk apparatus according to claim 1, wherein
when the movable holding device swings towards the surface of the base chassis, a position of the head or the guide shaft gets close to a parallel position relative to the surface of the base chassis, in comparison with positions of the movable holding device and the spindle motor, by moving independently of the movable holding device in the direction away from the surface of the base chassis.

3. The disk apparatus according to claim 1, wherein
when the movable holding device swings towards the surface of the base chassis, the head or the guide shaft is moved independently of the movable holding device in the direction away from the surface of the base chassis by coming into contact with the limiting device.

4. The disk apparatus according to claim 1, wherein
the limiting device is disposed on the guide shaft and extends towards the surface of the base chassis, and
a tip of the limiting device comes into contact with the surface of the base chassis, when the movable holding device swings toward the surface of the base chassis.

5. The disk apparatus according to claim 4, wherein
the head comprises: a light source for irradiating the recording medium with a light beam; and a photoreceiver for receiving the light beam reflected from the loaded recording medium, and
the limiting device is disposed near at least one of the light source and the photoreceiver.

6. The disk apparatus according to claim 1, wherein
the limiting device is disposed on the head and extends towards the surface of the base chassis, and
a tip of the limiting device comes into contact with the surface of the base chassis, when the movable holding device swings towards the surface of the base chassis.

7. The disk apparatus according to claim 1, wherein
the limiting device is disposed on the surface of the base chassis and extends toward the head or the guide shaft, and
a tip of the limiting device comes into contact with the head or the guide shaft, when the movable holding device swings towards the surface of the base chassis.

8. The disk apparatus according to claim 1, wherein
the movable holding device holds the guide shaft via an elastic device, and the elastic device is compressible in a direction away from the surface of the base chassis.
